(19) United States
(12) Patent Application Publication
(10) Pub. No.: US 2010/0201628 A1
(43) Pub. Date: Aug. 12, 2010

(54) ALPHABET INPUT SYSTEM FOR MOBILE TERMINAL

(76) Inventor: Ho-Youn Lee, Gyeonggi-do (KR)

Correspondence Address: DALY, CROWLEY, MOFFORD & DURKEE, LLP, SUITE 301A, 354A TURNPIKE STREET, CANTON, MA, 02021-2714, US

(21) Appl. No.: 12/670,028

(22) PCT Filed: Jul. 21, 2008
(86) PCT No.: PCT/KR08/04243

§ 371 Date: Jan. 21, 2010

(30) Foreign Application Priority Data
Aug. 3, 2007 (KR) 10-2007-0078103
Oct. 2, 2007 (KR) 10-2007-0099274

(51) Int. Cl. G06F 3/02

(52) U.S. Cl. 345/169

(57) ABSTRACT

An alphabet input system for a mobile terminal is provided, which can enable anyone to easily and rapidly input an alphabet using a combination of symbols having shapes that can be easily memorized by anyone. The alphabet input system includes a keypad, including 10 numeral keys ‘0’ to ‘9’, to which symbols ‘L’, ‘Λ’, ‘Γ’, ‘<’, ‘o’, ‘>’, ‘Γ’, ‘ν’, ‘Γ’, and ‘λ,’ are allocated, respectively, and keys ‘*’ and ‘#’, for inputting an alphabet through a combination of the keys, and a screen display unit for displaying the alphabet inputted through the key combination of the keypad on a display screen.

### TECHNICAL FIELD

The present invention relates to an alphabet input system for a mobile terminal. More particularly, the present invention relates to an alphabet input system for a mobile communication terminal that can enable anyone to easily memorize combinations of symbols having shapes similar to alphabets and input a desired alphabet using the corresponding combination of symbols.

### BACKGROUND ART

Generally, conventional alphabet input systems may be classified into an alphabet input system through arrangement of three or more alphabets for one numeral key, an alphabet input system through touch of a keyboard screen in the form of a computer keyboard that is displayed on a display screen using a pen and so on, and a T9 system that searches for a word most similar to an input alphabet through a pattern matching with a terminal database in which frequently used words are pre-stored.

The above-described alphabet input systems, however, have the drawbacks in that buttons should be inputted several times in order to input one alphabet.

On the other hand, in order to solve the above-described problem, an alphabet input system through a symbol combination by extracting and symbolizing a specified pattern when letters are written using the characteristic of the alphabet has been disclosed in Korean Patent Registration No. 10-0661457.

However, this alphabet input system requires the input of letters four times at maximum to input the alphabet. Also, the symbol combination may not be similar to the alphabet shape, and in this case, it is not easy for anyone to memorize the symbol combination.

### DISCLOSURE

### Technical Problem

Therefore, the present invention has been made in view of the above-mentioned problems.

An object of the present invention is to provide an alphabet input system for a mobile terminal which can enable anyone to easily and rapidly input an alphabet using a combination of symbols having shapes that can be easily memorized by anyone.

### Technical Solution

In order to achieve the above and other objects, there is provided an alphabet input system for a mobile terminal, according to the present invention, which includes a keypad, including 10 numeral keys ‘0’ to ‘9’, to which symbols [symbol] ‘<’, ‘∘’, ‘>’, [symbol] and [symbol] are allocated, respectively, and keys ‘*’ and ‘#’, for inputting an alphabet through a combination of the keys; and a screen display unit for displaying the alphabet inputted through the key combination of the keypad on a display screen; wherein each alphabet is displayed by successively inputting two of the keys in a manner that the keys ‘∘’ and [symbol] are successively inputted for alphabet ‘a’, the keys [symbol] and ‘∘’ for alphabet ‘b’, the keys ‘<’ and ‘*’ or the keys ‘<’ and ‘<’ for alphabet ‘c’, the keys ‘∘’ and [symbol] for alphabet ‘d’, the keys ‘∘’ and ‘<’ for alphabet ‘e’, the keys [symbol] and [symbol] for alphabet ‘f’, the keys ‘∘’ and ‘>’ for alphabet ‘g’, the keys [symbol] and [symbol] for alphabet ‘h’, the keys [symbol] and ‘*’ for alphabet ‘i’, the keys [symbol] and ‘*’ for alphabet ‘j’, the keys [symbol] and ‘<’ for alphabet ‘k’, the keys [symbol] and ‘*’ or the keys [symbol] and [symbol] for alphabet ‘l’, the keys [symbol] and [symbol] for alphabet ‘m’, the keys [symbol] and ‘*’ for alphabet ‘n’, the keys ‘∘’ and ‘*’ for alphabet ‘o’, the keys [symbol] and ‘∘’ for alphabet ‘p’, the keys ‘∘’ and [symbol] for alphabet ‘q’, the keys [symbol] and [symbol] for alphabet ‘r’, the keys ‘<’ and ‘>’ for alphabet ‘s’, the keys [symbol] and [symbol] for alphabet ‘t’, the keys [symbol] and [symbol] for alphabet ‘u’, the keys [symbol] and ‘*’ for alphabet ‘v’, the keys [symbol] and [symbol] for alphabet ‘w’, the keys [symbol] and [symbol] for alphabet ‘x’, the keys [symbol] and [symbol] for alphabet ‘y’, and the keys ‘>’ and ‘<’ for alphabet ‘z’, respectively.

It is preferable that the keypad is constructed in a manner that the key [symbol] is allocated to numeral key ‘1’, the key [symbol] is allocated to numeral key ‘2’, the key [symbol] is allocated to numeral key ‘3’, the key ‘<’ is allocated to numeral key ‘4’, the key ‘∘’ is allocated to numeral key ‘5’, the key ‘>’ is allocated to numeral key ‘6’, the key [symbol] is allocate to numeral key ‘7’, the key [symbol] is allocated to numeral key ‘8’, the key [symbol] is allocated to numeral key ‘9’, and the key [symbol] is allocated to numeral key ‘0’.

More preferably, input of the key ‘#’ once corresponds to leaving space, and input of the key ‘#’ twice corresponds to conversion of capital/small letters or display of a special character. If at least two initial letters of a word are inputted during input of an alphabet through the key combination of the keypad, recently inputted words that include the initial letters among the frequently used words pre-stored in a database of an internal memory are arranged in order on a sub-menu screen, and the corresponding word is displayed on the screen through input of the key ‘#’ after selection of the desired word using the numeral key.

More preferably, the alphabet input system according to the present invention further include a mode conversion key for converting a direction key mode into a letter input mode and vice versa whenever the mode conversion key is pressed during the input of the alphabet, and in a direction key mode activated by the input of the mode conversion key, the key [symbol] functions as an upward direction key, the key ‘<’ functions as a left direction key, the key ‘>’ functions as a right direction key, and the key [symbol] functions as a downward direction key.

In another aspect of the present invention, there is provided an alphabet input system for a mobile terminal, which includes a keypad including numeral keys ‘1’ to ‘9’, to which symbols [symbol] and ‘−’, ‘<’, ‘∘’, ‘>’, [symbol] and [symbol] and ‘−’ are allocated, respectively, and keys ‘*’ and ‘#’; wherein each alphabet is displayed by successively inputting a combination of two of the keys in a manner that a combination of the keys ‘∘’ and [symbol] is inputted for alphabet ‘a’, the keys [symbol] and ‘∘’ for alphabet ‘b’, the keys ‘<’ and ‘<’ for alphabet ‘c’, the keys ‘∘’ and [symbol] for alphabet ‘d’, the keys ‘∘’ and ‘<’ for alphabet ‘e’, the keys [symbol] and [symbol] or the keys [symbol] and ‘−’ for alphabet ‘f’, the keys ‘∘’ and ‘>’ for alphabet ‘g’, the keys [symbol] and [symbol] for alphabet ‘h’, the keys [symbol] and ‘∘’ for alphabet ‘i’, the keys [symbol] and ‘*’ for alphabet ‘j’, the keys [symbol] and ‘<’ for alphabet ‘k’, the keys [symbol] and [symbol] for alphabet ‘l’, the keys [symbol] and [symbol] for alphabet ‘m’, the keys [symbol] and [symbol] or the keys [symbol] and ‘∘’ for alphabet ‘n’, the keys ‘∘’ and ‘∘’ for alphabet ‘o’, the keys [symbol] and ‘∘’ for alphabet ‘p’, the keys ‘∘’ and [symbol] for alphabet ‘q’, the keys [symbol] and [symbol] for alphabet ‘r’, the keys ‘−’ and ‘>’ for alphabet ‘s’, the keys [symbol] and ‘−’ for alphabet ‘t’, the keys [symbol] and [symbol] for alphabet ‘u’, the keys [symbol] and ‘*’ or the keys [symbol] and ‘∘’ for alphabet ‘v’, the keys [symbol] and [symbol] for alphabet ‘w’, the keys [symbol] and [symbol] for alphabet ‘x’, the keys [symbol] and [symbol] for alphabet ‘y’, and the keys ‘>’ and ‘−’ for alphabet ‘z’, respectively.

### ADVANTAGEOUS EFFECTS

As described above, the alphabet input system for a mobile communication terminal according to the present invention enables anyone to easily memorize combinations of symbols having basic shapes of alphabets and input an alphabet using the corresponding combination of symbols. Also, since an alphabet can be inputted through input of the symbols twice at maximum, a rapid input of the alphabet can be achieved.

In addition, by providing a direction key function through a keypad, space occupied by direction keys provided in a mobile terminal can be used for display to heighten the space utility.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a view illustrating the construction of a keypad of an alphabet input system for a mobile terminal according to a first embodiment of the present invention;

FIG. 2 is a flowchart for inputting ‘nominate’ through the use of an alphabet input system according to the first embodiment of the present invention;

FIG. 3 is a flowchart for inputting ‘nominate’ through the use of an alphabet input system according to a second embodiment of the present invention;

FIG. 4 is a view illustrating an example of a sub-menu screen for providing a history function through the use of the alphabet input system according to the present invention; and

FIG. 5 is a view illustrating the construction of a keypad of an alphabet input system for a mobile terminal according to a third embodiment of the present invention.

### BEST MODE

Reference will now be made in detail to the preferred embodiments of the present invention. It is to be understood that the following examples are illustrative only and the present invention is not limited thereto.

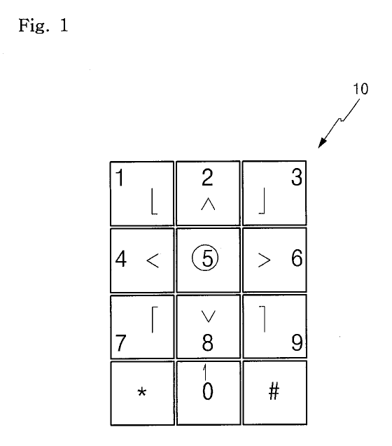

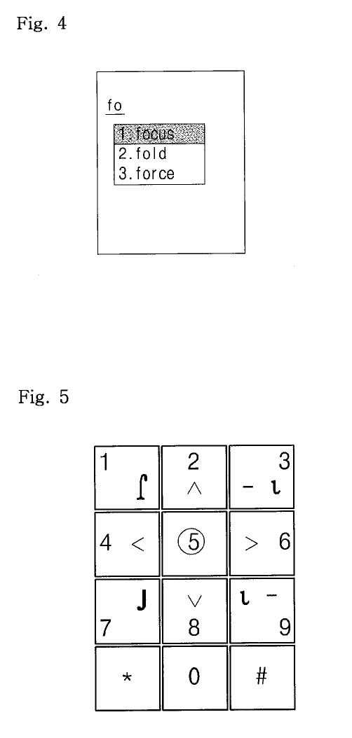

FIG. 1 is a view illustrating the construction of a keypad of an alphabet input system for a mobile terminal according to a first embodiment of the present invention, and FIG. 4 is a view illustrating an example of a sub-menu screen for providing a history function through the use of the alphabet input system according to the first embodiment of the present invention.

With reference to FIGS. 1 and 4, the alphabet input system for a mobile terminal according to the first embodiment of the present invention will be described in detail.

As shown in FIG. 1, 10 symbols having basic shapes of alphabets are allocated to numeral keys ‘0’ to ‘9’ in a keypad 10.

In the case of inputting alphabet small letters ‘a’ to ‘z’ through combinations of the symbols, the corresponding symbols are most closely arranged in consideration of fingers' moving distances, and thus a rapid alphabet input becomes possible.

That is, a symbol is allocated to the numeral key ‘1’, a symbol [symbol] is allocated to the numeral key ‘2’, a symbol [symbol] is allocated to the numeral key ‘3’, a symbol ‘<’ is allocated to the numeral key ‘4’, a symbol ‘∘’ is allocated to the numeral key ‘5’, a symbol ‘>’ is allocated to the numeral key ‘6’, a symbol [symbol] is allocate to the numeral key ‘7’, a symbol [symbol] is allocated to the numeral key ‘8’, a symbol [symbol] is allocated to the numeral key ‘9’, and a symbol [symbol] is allocated to the numeral key ‘0’. Also, keys ‘*’ and ‘#’ are arranged in the keypad.

Combinations of the symbols allocated to the 10 numeral keys and the key ‘*’, for the alphabets ‘a’ to ‘z’, in consideration of the shapes of the alphabet small letters, are given in Table 1 as bellow.

As can be seen in Table 1, the symbol combinations for the alphabets ‘a’ to ‘z’ are arranged to be most similar to the shapes of the alphabets, and the respective alphabet can be displayed through the input of the symbols twice at maximum, a rapid input of the corresponding alphabet can be achieved.

TABLE 1

| | | |
|---|---|---|
| [symbol] lpha | Symbol | |
| [symbol] et | Combination | Remarks |

| | |
|---|---|
| ‘o’ + [symbol] | 5 + 0 |
| [symbol] + ‘o’ | 1 + 5 |
| ‘<’ + ‘*’ or | In case of + |
| ‘<’ + ‘<’ | vowel, ‘<’ is |
| | inputted (4 + * |
| | or 4 + 4) |
| ‘o’ + [symbol] | 5 + 3 |
| ‘o’ + ‘<’ | 5 + 4 |
| [symbol] + [symbol] | 3 + 7 |
| ‘o’ + ‘>’ | 5 + 6 |
| [symbol] + [symbol] | 1 + 2 |
| [symbol] + ‘*’ | 0 + * |
| [symbol] + ‘*’ | 7 + * |
| [symbol] + ‘<’ | 1 + 4 |
| [symbol] + ‘*’ or | In case of + |
| [symbol] + [symbol] | vowel, [symbol] is |
| | inputted (3 + * |
| | or 3 + 3) |
| [symbol] + [symbol] | 2 + 2 |
| [symbol] + ‘*’ | In case of + |
| | vowel, [symbol] is |
| | inputted (2 + *) |
| ‘o’ + ‘*’ or | 5 + * or 5 + 5 |
| ‘o’ + ‘o’ | |
| [symbol] + ‘o’ | 7 + 5 |
| ‘o’ + [symbol] | 5 + 9 |
| [symbol] + [symbol] | 0 + 2 |
| ‘<’ + ‘>’ | 4 + 6 |
| [symbol] + [symbol] | 0 + 0 |
| [symbol] + [symbol] | 8 + 0 |
| [symbol] + ‘*’ | In case of + |
| | vowel, [symbol] is |
| | inputted (8 + *) |
| [symbol] + [symbol] | 8 + 8 |
| [symbol] + [symbol] | 8 + 2 |
| [symbol] + [symbol] | 8 + 9 |
| ‘>’ + ‘<’ | 6 + 4 |

[symbol]

indicates data missing or illegible when filed

Particularly, two combinations are given for each of the alphabets ‘c’, ‘l’, and ‘o’, and this is to conveniently input the combinations to suit the fingers' moving distance and the user's taste.

The symbol combinations for the alphabets are most closely arranged so as to shorten the fingers' moving distances at maximum. As can be seen in remarks of Table 1, the maximum fingers' moving distance (i.e. the distance between the numeral keys) refers to the input of the alphabets ‘c’, ‘l’, and ‘o’ (in the case of the alphabets ‘c’, ‘l’, and ‘o’, two kinds of combinations are given), and thus a rapid alphabet input becomes possible.

Also, the alphabets ‘c’, ‘l’, ‘n’, and ‘v’ provide a shortcut key function. If a symbol combination for inputting a vowel is performed after a front one of two symbols for inputting an alphabet is inputted, two alphabets can be inputted through the input of symbols only three times, and thus the shortcut key function can be provided.

For example, in the case of inputting a word “vote”, 8, 5, *, 0, 0, 5, and 4 (i.e. the input of symbols seven times) are successively inputted to display “vote” on the screen.

On the other hand, function keys provided for user's convenience in inputting alphabets are given in Table 2.

TABLE 2

| Function Key | Function |
|---|---|
| * | Shortcut key function |
| | In case of inputting alphabet + *, |
| | corresponding alphabet copy function |
| # | Space function |
| | Capital/small letter conversion function |
| | Special character display function |
| | Function of selecting alphabet pre-stored in |
| | history |
| Mode | Letter input mode/direction key input mode |
| conversion key | conversion function |

The key ‘*’ provided on the keypad 10 provides a letter copy function to avoid a repeated input of the same alphabet, in addition to the shortcut key function.

For example, in the case of inputting ‘tt’, by pressing 0+0+*, ‘t’ corresponding to 0-0 is copied, and ‘tt’ is displayed on the screen, so that the same alphabet can be inputted twice through the input of the symbols only three times.

Also, the key ‘#’ provided on the keyboard 10 has diverse functions including a space function, a capital/small letter conversion function, and a special character display function.

If the key ‘#’ is inputted once during the input of the alphabet in order to use the space function, a cursor is automatically moved once to provide the space function.

The capital/small letter conversion function is performed when the key ‘#’ is inputted twice. If the key ‘#’ is inputted twice in a small letter mode, the small letters are converted into capital letters, while if the key ‘#’ is inputted twice in a capital letter mode; the capital letters are converted into small letters.

Also, the special character display function is performed through the use of the key ‘#’. Preferably, a special character display window is displayed on the screen through the input of the key ‘#’ three times, a desired special character is searched for, and then a numeral allocated to the corresponding special character is inputted to input the special character.

In this case, special characters provided for the special character display function basically include apostrophe in English, umlaut in German, accent aigu and accent grave in French, and the like, and thus the alphabet input system can be used in not only English-speaking countries but also alphabet-using countries.

Also, the key ‘#’ can be used as a key for using a history function.

In order to perform the history function, a history database, which provides a history list for storing words through the input of alphabets in the order of their input, is provided in an internal memory of the mobile terminal. The history function is a kind of word memorizing function for searching for and inputting the recently inputted words including the inputted alphabets through the history list screen during the input of the alphabets.

As an example, a word input method using the history function will be described. As illustrated in FIG. 4, if ‘fo’ is inputted, ‘focus’, ‘fold’, and ‘force’, which are pre-stored in the history database, are provided on a sub-menu screen, in the order of their input, and ‘force’ among them can be inputted by inputting 3+#.

On the other hand, the mode conversion key may be separately provided to convert a letter input mode for inputting alphabets into a direction key mode for using a part of the keypad 10 as direction keys, and vice versa.

That is, if the mode conversion key is inputted once in a letter input mode, the mode is converted into a direction key mode, while if the mode conversion key is inputted once more in the direction key mode, the mode is converted into the letter input mode. In a state where the direction key mode is activated, the numeral keys ‘2’, ‘4’, ‘6’, and ‘8’, which include respective direction keys, serve as upward, left, right, and downward direction keys, respectively.

The mode conversion key may be separately provided in the mobile terminal, or a key on the keypad 10 or a key outside the keypad 10 may be used as the mode conversion key as occasion demands.

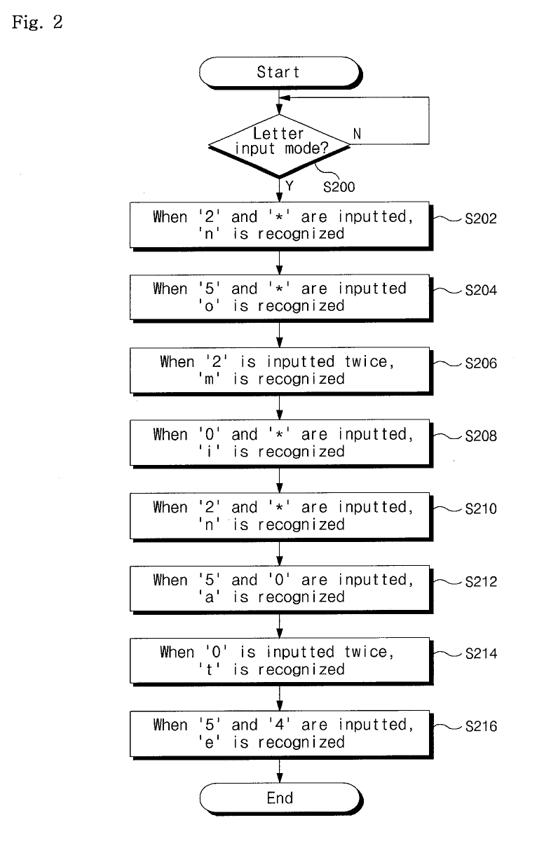

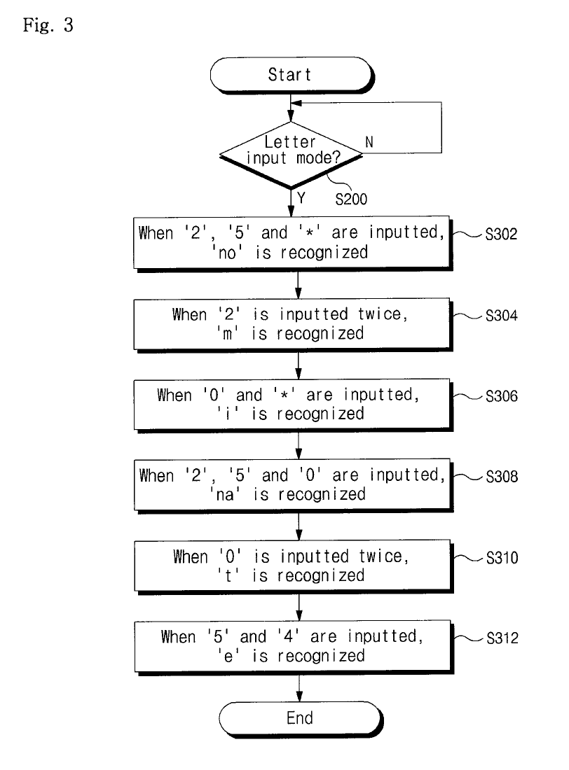

FIG. 2 is a flowchart for inputting ‘nominate’ through the use of an alphabet input system according to the first embodiment of the present invention, and FIG. 3 is a flowchart for inputting ‘nominate’ through the use of an alphabet input system according to a second embodiment of the present invention. In the first and second embodiments of the present invention, the same keypad 10 is used as shown in FIG. 1. However, in the second embodiment of the present invention, a shortcut key function is supported, unlike the first embodiment.

Referring to FIG. 2, a process of inputting ‘nominate’ in accordance with the first embodiment of the present invention will be described.

First, in order to input ‘nominate’ through the keypad 10, the numeral key ‘2’ and the key ‘*’ are successively inputted in a state where the letter input mode is activated, and thus alphabet ‘n’ is recognized and displayed on the screen (steps S200 and S202).

Then, by successively inputting the numeral key ‘5’ and the key ‘*’, alphabet ‘o’ is recognized and displayed on the screen (step S204).

Then, by inputting the numeral key ‘2’ twice, alphabet ‘m’ is recognized and displayed on the screen (step S206).

Thereafter, by inputting the numeral key ‘2’ and the key ‘*’, alphabet ‘i’ is recognized and displayed on the screen (step S208).

In the same manner, alphabet ‘n’ is recognized and displayed by the input of the numeral key ‘2’ and the key ‘*’, alphabet ‘a’ is recognized and displayed on the screen by the input of the numeral keys ‘5’ and ‘0’, alphabet ‘t’ is recognized and displayed on the screen by the input of the numeral key ‘0’ twice, and then alphabet ‘e’ is recognized and displayed on the screen by the input of the numeral keys ‘5’ and ‘4’ to complete the word ‘nominate’ (steps S210, S212, S214, and S216).

Accordingly, the input of keys 16 times is required to input the word ‘nominate’. However, by using the shortcut key function, a rapid alphabet input becomes possible. That is, in the case of inputting ‘nominate’ according to the second embodiment of the present invention that supports the shortcut key function, an input process can be shortened in comparison to the first embodiment of the present invention, and such an input process will now be described in detail with reference to FIG. 3.

First, if the numeral keys ‘2’ and ‘5’ and the key ‘*’ are successively inputted in a state where the letter input mode is activated, alphabets ‘no’ are recognized by the shortcut key function, and is displayed on the screen (steps S300 and S302). As described above, in the case of inputting the alphabet ‘n’, the present invention provides the shortcut key function. In principle, in order to input ‘n’, a user should press the numeral key ‘2’ and then press the key ‘*’. However, in the case of inputting a word ‘no’, ‘n’ is combined with a vowel ‘o’, and thus the above-described shortcut key function can be used. That is, by inputting two symbols (i.e. the numeral key ‘5’ and the key ‘*’) for inputting the vowel after the input of a front symbol (i.e. the numeral key ‘2’) of a combination of two symbols (i.e. the numeral key ‘2’ and the key ‘*’) for inputting ‘n’, two alphabets ‘no’ can be inputted. In other words, two alphabets ‘no’ can be inputted through the input of symbols only three times.

Then, by inputting the numeral key ‘2’ twice, ‘m’ is recognized and displayed, and by inputting the numeral key ‘0’ and the key ‘*’, T is recognized and displayed on the screen as the next letter (steps S304 and S306).

Also, if a user inputs the numeral key ‘5’ and the key ‘*’ after inputting the numeral key ‘2’ using the shortcut key function, alphabets ‘na’ are inputted and displayed on the screen (step S308).

Then, by inputting the numeral key ‘0’ twice, ‘t’ is displayed on the screen, and by inputting again the numeral keys ‘5’ and ‘4’, ‘e’ is inputted, so that desired alphabets are inputted (steps S310 and S312).

According to the alphabet input system using the shortcut key function as shown in FIG. 3, the corresponding word can be inputted through the input of symbols only 14 times.

FIG. 5 is a view illustrating the construction of a keypad of an alphabet input system for a mobile terminal according to a third embodiment of the present invention. Hereinafter, the alphabet input system for a mobile terminal according to the third embodiment of the present invention will be described in detail with reference to the accompanying drawings.

As illustrated in FIG. 5, a line and a circle of specified shapes are allocated to each key on a keypad of the alphabet input system for a mobile terminal according to the third embodiment of the present invention. In comparison to the first and second embodiments of the present invention as described above, the alphabet input system according to the third embodiment of the present invention is constructed so that a user can conveniently input alphabets with a minimum moving line of a finger. Preferably, in the case of applying the alphabet input system to a mobile terminal provided with a touchpad type keypad, a user can input the alphabet by moving his/her finger in a state where the user touches the keypad, and this provides great convenience to the user. The alphabet input system according to the third embodiment of the present invention is called ‘PICTOS’.

Referring to FIG. 5, which includes a keypad including numeral keys ‘1’ to ‘9’, to which symbols a symbol [symbol] is allocated to the numeral key ‘1’ on the keypad of the mobile terminal according to the third embodiment of the present invention, [symbol] is allocated to the numeral key ‘2’, and [symbol] are allocated to the numeral key ‘3’, ‘<’ is allocated to the numeral key ‘4’, and ‘∘’ is allocated to the numeral key ‘5’. Also, ‘>’ is allocated to the numeral key 6, [symbol] is allocated to the numeral key 7, [symbol] is allocated to the numeral key 8, and [symbol] and are allocated to the numeral key ‘9’. The user inputs a desired alphabet by manipulating the above-described key and the key ‘*’.

Table 3 below shows combinations of symbols allocated to 10 numeral keys for inputting alphabets and a key ‘*’ according to the third embodiment of the present invention.

TABLE 3

| Al- | | | |
|---|---|---|---|
| pha- | | Descrip- | |
| bet | Symbol | tion | Drawing |
| [symbol] | [symbol] | [symbol] | 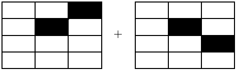 |
| [symbol] | [symbol] | [symbol] | 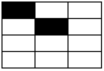 |
| [symbol] | [symbol] | [symbol] | 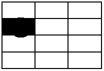 |
| [symbol] | [symbol] | [symbol] | 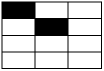 |
| [symbol] | [symbol] | [symbol] | 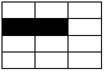 |
| [symbol] | [symbol] | [symbol] | 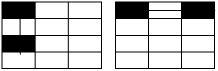 |
| [symbol] | [symbol] | [symbol] | 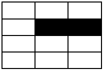 |
| [symbol] | [symbol] | [symbol] | 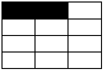 |
| [symbol] | [symbol] | [symbol] | 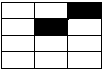 |
| [symbol] | [symbol] | [symbol] | 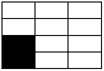 |
| [symbol] | [symbol] | [symbol] | 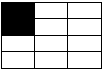 |
| [symbol] | [symbol] | [symbol] | 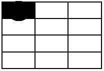 |
| [symbol] | [symbol] | [symbol] | 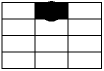 |
| [symbol] | [symbol] | [symbol] | 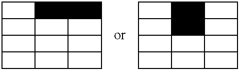 |
| [symbol] | [symbol] | [symbol] | 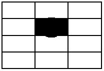 |
| [symbol] | [symbol] | [symbol] | 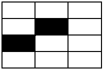 |
| [symbol] | [symbol] | [symbol] | 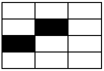 |
| [symbol] | [symbol] | [symbol] | 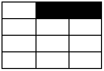 |
| [symbol] | [symbol] | [symbol] | 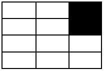 |
| [symbol] | [symbol] | [symbol] | 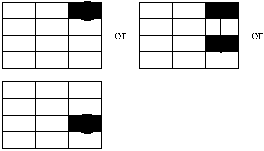 |
| [symbol] | [symbol] | [symbol] | 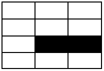 |
| [symbol] | [symbol] | [symbol] | 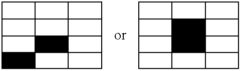 |
| [symbol] | [symbol] | [symbol] | 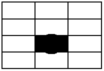 |
| [symbol] | [symbol] | [symbol] | 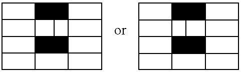 |
| [symbol] | [symbol] | [symbol] | 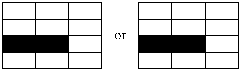 |
| [symbol] | [symbol] | [symbol] | 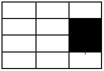 |

As shown in Table 3, the keypad (lines and circles of specified shapes allocated to the keypad) according to the present invention is constructed so that a user can intuitively input alphabets through combinations of symbols allocated to the keys. Also, by allocating ‘−’ and [symbol] to the numeral key ‘3’ and allocating [symbol] and ‘−’ to the numeral key ‘9’, the moving line that should be manipulated by the user during the input of the alphabets can be minimized. In the case of manipulating the numeral keys to which two symbols are allocated, i.e. the numeral keys ‘3’ and ‘9’, the mobile terminal judges the combined and inputted symbols, and recognizes the symbol as ‘−’ or [symbol] . For example, if a user input the numeral key ‘3’ and then the numeral key ‘6’ in order to input the alphabet ‘s’, the mobile terminal judges the symbol corresponding to the numeral key 3 as ‘−’, and displays ‘s’, while if the user input the numeral key ‘5’ and then the numeral key ‘3’ in order to input the alphabet ‘a’, the mobile terminal judges the symbol corresponding to the numeral key 3 as [symbol] and displays ‘a’.

With reference to Table 3, combinations of symbols for inputting alphabets through the use of the alphabet input system according to the third embodiment of the present invention will be described.

In the embodiment of the present invention, a combination of keys ‘∘’ and [symbol] (i.e. numeral key ‘5’+numeral key ‘3’ or numeral key ‘9’) (here, ‘+’ means successive manipulation of the keys) is inputted for alphabet ‘a’, a combination of keys [symbol] and ‘∘’ (i.e. numeral key ‘1’+numeral key ‘5’) is inputted for alphabet ‘b’, and a combination of keys ‘<’ and ‘<’ (i.e. numeral key ‘4’+numeral key ‘4’: which correspond to the input of numeral key ‘4’ twice, the pressing of numeral key ‘4’ over a predetermined time, or the drawing of a circle on the corresponding touchpad type keypad as shown in Table 3) is inputted for alphabet ‘c’. A combination of keys ‘∘’ and [symbol] (i.e. numeral key ‘5’+numeral key ‘1’) is inputted for alphabet ‘d’, a combination of keys ‘∘’ and ‘<’ (i.e. numeral key ‘5’+numeral key ‘4’) is inputted for alphabet ‘e’, and a combination of keys [symbol] and [symbol] (i.e., numeral key ‘1’+numeral key ‘7’) or a combination of keys [symbol] and ‘−’ (i.e. numeral key ‘1’+numeral key “3) is inputted for alphabet ‘f’. A combination of keys ‘∘’ and ‘>’ (i.e. numeral key ‘5’+numeral key ‘6’) is inputted for alphabet ‘g’, a combination of keys [symbol] and [symbol] (i.e., numeral key ‘1’+numeral key ‘2’) is inputted for alphabet ‘h’, and a combination of keys [symbol] and ‘◯’ (i.e. numeral key ‘3’+numeral key ‘5’) is inputted for alphabet ‘i’.

Also, a combination of keys [symbol] and ‘*’ (i.e. numeral key ‘7’+key ‘*’) is inputted for alphabet ‘j’, a combination of keys [symbol] and ‘<’ (i.e. numeral key ‘1’+numeral key ‘4’) is inputted for alphabet ‘k’, and a combination of keys [symbol] and [symbol] (i.e. numeral key ‘1’+numeral key ‘1’: which correspond to the input of numeral key ‘1’ twice, the pressing of numeral key ‘1’ over a predetermined time, or the drawing of a circle on the corresponding touchpad type keypad as shown in Table 3) is inputted for alphabet ‘l’. A combination of keys [symbol] and [symbol] (i.e. numeral key ‘2’+numeral key ‘2’: which correspond to the input of numeral key ‘2’ twice, the pressing of numeral key ‘2’ over a predetermined time, or the drawing of a circle on the corresponding touchpad type keypad as shown in Table 3) is inputted for alphabet ‘m’, a combination of keys [symbol] and [symbol] (i.e. numeral key ‘2’+numeral key ‘3’) or a combination of keys [symbol] and ‘∘’ (i.e. numeral key ‘2’+numeral key ‘5’) is inputted for alphabet ‘n’, and a combination of keys ‘∘’ and ‘∘’ (i.e. numeral key ‘5’+numeral key ‘5’: which correspond to the input of numeral key ‘5’ twice, the pressing of numeral key ‘5’ over a predetermined time, or the drawing of a circle on the corresponding touchpad type keypad as shown in Table 3) is inputted for alphabet ‘o’.

Also, a combination of keys [symbol] and ‘∘’ (i.e. numeral key ‘7’+numeral key ‘5’) is inputted for alphabet ‘p’, a combination of keys ‘∘’ and [symbol] (i.e. numeral key ‘5’+numeral key ‘7’) is inputted for alphabet ‘q’, and a combination of keys [symbol] and [symbol] (i.e. numeral key ‘3’+numeral key ‘2’) is inputted for alphabet ‘r’. A combination of keys ‘−’ and ‘>’ (i.e. numeral key ‘3’+numeral key ‘6’) is inputted for alphabet ‘s’, a combination of keys [symbol] and ‘−’ (i.e. numeral key ‘3’+numeral key ‘3’, numeral key ‘9’+numeral key ‘9’, or numeral key ‘3’+numeral key ‘9’: which correspond to the input of numeral key ‘3’ or numeral key ‘9’ twice, the pressing of numeral key ‘3’ or numeral key ‘9’ over a predetermined time, or the drawing of a circle on the corresponding touchpad type keypad (corresponding to numeral key ‘3’ or numeral key ‘9’) as shown in Table 3) is inputted for alphabet ‘t’, and a combination of keys [symbol] and [symbol] (i.e., numeral key ‘8’+numeral key ‘9’) is inputted for alphabet ‘u’.

Also, a combination of keys [symbol] and ‘*’ (i.e. numeral key ‘8’+key ‘*’) or a combination of keys [symbol] and ‘∘’ (i.e. numeral key ‘8’+numeral key ‘5’) is inputted for alphabet ‘v’, a combination of keys [symbol] and [symbol] (i.e., numeral key ‘8’+numeral key ‘8’: which correspond to the input of numeral key ‘8’ twice, the pressing of numeral key ‘8’ over a predetermined time, or the drawing of a circle on the corresponding keypad (corresponding to numeral key ‘8’) as shown in Table 3) is inputted for alphabet ‘w’, and a combination of keys [symbol] and [symbol] (i.e., numeral key ‘2’+numeral key ‘8’, or numeral key ‘8’+numeral key ‘2’) is inputted for alphabet ‘x’. A combination of keys [symbol] and [symbol] (i.e. numeral key ‘7’+numeral key ‘8’, or numeral key ‘8’+numeral key ‘7’) is inputted for alphabet ‘y’, and a combination of keys ‘>’ and ‘−’ (i.e. numeral key ‘6’+numeral key ‘9’) is inputted for alphabet ‘z’.

The alphabet input system according to the third embodiment of the present invention, in the same manner as the first and second embodiments of the present invention, may be constructed to support various kinds of function key functions as shown in Table 2. That is, the key ‘*’ provided on the keypad 10 provides a letter copy function to avoid a repeated input of the same alphabet, in addition to a shortcut key function.

Also, the key ‘#’ provided on the keyboard 10 has diverse functions including a space function, a capital/small letter conversion function, and a special character display function, and thus can be used as a key for using a history function in addition to the above-described basic functions.

On the other hand, the mode conversion key may be separately provided to convert a letter input mode for inputting alphabets into a direction key mode for using a part of the keypad 10 as direction keys, and vice versa. That is, if the mode conversion key is inputted once in a letter input mode, the mode is converted into a direction key mode, while if the mode conversion key is inputted once more in the direction key mode, the mode is converted into the letter input mode. In a state where the direction key mode is activated, the numeral keys ‘2’, ‘4’, ‘6’, and ‘8’, which include respective direction keys, serve as upward, left, right, and downward direction keys, respectively.

The construction and function of the function keys are the same as those in the first and second embodiments of the present invention, and thus the detailed description thereof will be omitted.

While this invention has been described in connection with what is presently considered to be the most practical and preferred embodiments, it is to be understood that the invention is not limited to the disclosed embodiment and the drawings. On the contrary, it is intended to cover various modifications and variations within the spirit and scope of the appended claims.

1. An alphabet input system for a mobile terminal, comprising keys of a terminal keypad each being allocated with a line and a circle of specified shapes, wherein an alphabet is inputted through a combination of the line and the circle inputted in accordance with a user's manipulation of the keys.

2. The alphabet input system of claim 1, further comprising:
a keypad, including 10 numeral keys ‘0’ to ‘9’, to which symbols [symbol] , ‘<’, ‘∘’, ‘>’, [symbol] and [symbol] are allocated, respectively, and keys ‘*’ and ‘#’, for inputting an alphabet through a combination of the keys; and
a screen display unit for displaying the alphabet inputted through the key combination of the keypad on a display screen;
wherein each alphabet is displayed by successively inputting two of the keys in a manner that the keys ‘∘’ and [symbol] are successively inputted for alphabet ‘a’, the keys [symbol] and ‘∘’ for alphabet ‘b’, the keys ‘<’ and ‘*’ or the keys ‘<’ and ‘<’ for alphabet ‘c’, the keys ‘∘’ and [symbol] for alphabet ‘d’, the keys ‘∘’ and ‘<’ for alphabet ‘e’, the keys [symbol] and [symbol] for alphabet ‘f’, the keys ‘∘’ and ‘>’ for alphabet ‘g’, the keys [symbol] and [symbol] for alphabet ‘h’, the keys [symbol] and ‘*’ for alphabet ‘i’, the keys [symbol] and ‘*’ for alphabet ‘j’, the keys [symbol] and ‘<’ for alphabet ‘k’, the keys [symbol] and ‘*’ or the keys [symbol] and [symbol] for alphabet ‘l’, the keys [symbol] and [symbol] for alphabet ‘m’, the keys [symbol] and ‘*’ for alphabet ‘n’, the keys ‘∘’ and ‘*’ for alphabet ‘o’, the keys [symbol] and ‘∘’ for alphabet ‘p’, the keys ‘∘’ and [symbol] for alphabet ‘q’, the keys [symbol] and [symbol] for alphabet ‘r’, the keys ‘<’ and ‘>’ for alphabet ‘s’, the keys [symbol] and [symbol] for alphabet ‘t’, the keys [symbol] and [symbol] for alphabet ‘u’, the keys [symbol] and ‘*’ for alphabet ‘v’, the keys [symbol] and [symbol] for alphabet ‘w’, the keys [symbol] and [symbol] for alphabet ‘x’, the keys [symbol] and ‘┐’ for alphabet ‘y’, and the keys ‘>’ and ‘<’ for alphabet ‘z’, respectively.

3. The alphabet input system of claim 2, wherein the key pad is constructed in a manner that the key [symbol] is allocated to numeral key ‘1’, the key [symbol] is allocated to numeral key ‘2’, the key [symbol] is allocated to numeral key ‘3’, the key ‘<’ is allocated to numeral key ‘4’, the key ‘∘’ is allocated to numeral key ‘5’, the key ‘>’ is allocated to numeral key ‘6’, the key [symbol] is allocate to numeral key ‘7’, the key [symbol] is allocated to numeral key ‘8’, the key [symbol] is allocated to numeral key ‘9’, and the key [symbol] is allocated to numeral key ‘0’.

4. The alphabet input system of claim 2, further comprising a mode conversion key for converting a direction key mode into a letter input mode and vice versa whenever the mode conversion key is pressed during the input of the alphabet;
Wherein, in a direction key mode activated by the input of the mode conversion key, the key [symbol] functions as an upward direction key, the key ‘<’ functions as a left direction key, the key ‘>’ functions as a right direction key, and the key [symbol] functions as a downward direction key.

5. The alphabet input system of any one of claims 2 to 4, wherein the key ‘#’ is constructed so that an input of the key ‘#’ once corresponds to leaving space, and input of the key ‘#’ twice corresponds to conversion of capital/small letters or display of a special character; and
Wherein, if at least two initial letters of a word are inputted during input of an alphabet through the key combination of the keypad, recently inputted words that include the initial letters among the frequently used words pre-stored in a database of an internal memory are arranged in order on a sub-menu screen, and the corresponding word is displayed on the screen through input of the key ‘#’ after selection of the desired word using the numeral key.

6. The alphabet input system of claim 1, wherein the line corresponds to [symbol] ‘<’, ‘>’, [symbol] and ‘−’, the circle corresponds to ‘∘’; and
wherein each alphabet is displayed by successively inputting a combination of two of the keys in a manner that a combination of the keys ‘∘’ and ‘ι’ is inputted for alphabet ‘a’, the keys [symbol] and ‘∘’ for alphabet ‘b’, the keys ‘<’ and ‘<’ for alphabet ‘c’, the keys ‘∘’ and [symbol] for alphabet ‘d’, the keys ‘∘’ and ‘<’ for alphabet ‘e’, the keys [symbol] and [symbol] or the keys [symbol] and ‘−’ for alphabet ‘f’, the keys ‘∘’ and ‘>’ for alphabet ‘g’, the keys [symbol] and [symbol] for alphabet ‘h’, the keys ‘ [symbol] ’ and ‘∘’ for alphabet ‘i’, the keys [symbol] and ‘*’ for alphabet ‘j’, the keys [symbol] and ‘<’ for alphabet ‘k’, the keys [symbol] and [symbol] for alphabet ‘l’, the keys [symbol] and [symbol] for alphabet ‘m’, the keys [symbol] and [symbol] or the keys [symbol] and ‘∘’ for alphabet ‘n’, the keys ‘∘’ and ‘∘’ for alphabet ‘o’, the keys [symbol] and ‘∘’ for alphabet ‘p’, the keys ‘∘’ and [symbol] for alphabet ‘q’, the keys [symbol] and [symbol] for alphabet ‘r’, the keys ‘−’ and ‘>’ for alphabet ‘s’, the keys ‘ι’ and ‘−’ for alphabet ‘t’, the keys [symbol] and [symbol] for alphabet ‘u’, the keys [symbol] and ‘*’ or the keys [symbol] and ‘∘’ for alphabet ‘v’, the keys [symbol] and [symbol] for alphabet ‘w’, the keys [symbol] and [symbol] for alphabet ‘x’, the keys [symbol] and [symbol] for alphabet ‘y’, and the keys ‘>’ and ‘−’ for alphabet ‘z’, respectively.

7. The alphabet input system of claim 6, wherein the key [symbol] is allocated to numeral key ‘1’, the key [symbol] is allocated to numeral key ‘2’, the keys [symbol] and ‘−’ are allocated to numeral key ‘3’, the key ‘<’ is allocated to numeral key ‘4’, the key ‘∘’ is allocated to numeral key ‘5’, the key ‘>’ is allocated to numeral key ‘6’, the key [symbol] is allocate to numeral key ‘7’, the key [symbol] is allocated to numeral key ‘8’, and the keys [symbol] and ‘−’ are allocated to numeral key ‘9’.

8. The alphabet input system of claim 7, wherein the keypad comprises a touchpad; and
wherein, if the circle is drawn on a specified numeral key, a shape allocated to the specified numeral key is successively inputted twice.
